(19) United States
(12) Patent Application Publication
(10) Pub. No.: US 2025/0190480 A1
(43) Pub. Date: Jun. 12, 2025

(54) SYSTEM AND A METHOD OF TRAINING A MACHINE-LEARNING MODELS FOR SEARCH RESULTS RANKING

(71) Applicant: Y.E. Hub Armenia LLC, Yerevan (AM)

(72) Inventors: Aleksandr BOIMEL, Reutov (RU); Daniil GUSEV, Dzerzhinsk (RU); Andrei KULUNCHAKOV, Penzav (RU); Artem MIRONOV, Kaluga (RU)

(21) Appl. No.: 18/974,147

(22) Filed: Dec. 9, 2024

(30) Foreign Application Priority Data
Dec. 12, 2023 (RU) 2023132781

(51) Int. Cl. G06F 16/383; G06F 16/334

(52) U.S. Cl. CPC G06F 16/383; G06F 16/3344; G06F 16/3347

(57) ABSTRACT

A method and a server for ranking digital documents at a digital platform are provided. The method comprises: receiving a search query submitted to the digital platform; generating a first vector embedding representative of the search query; identifying a plurality of digital document candidates responsive to the search query; retrieving, for each one of the plurality of digital document candidates, a second vector embedding representative; identifying, in a given one of the plurality of digital document candidates, at least one phrase candidate that is lexically related to the search query; generating a third vector embedding representative of the at least one phrase candidate; based on the first, second, and third vector embeddings, determining, for the given one of the plurality of digital document candidates, a respective value of a ranking parameter; and ranking the plurality of digital document candidates according to respective values of the ranking parameter.

### CROSS-REFERENCE

The present application claims priority to Russian Patent Application No. 2023132781, entitled “System and a Method of Training a Machine-Learning Models for Search Results Ranking”, filed Dec. 12, 2023, the entirety of which is incorporated herein by reference.

### FIELD OF TECHNOLOGY

The present technology relates to machine-learning methods, and more specifically, to methods and systems for training and using machine-learning models for search results ranking.

### BACKGROUND

Web search is one of the pivotal technologies nowadays, with billions of user queries processed daily. Current web search systems typically rank search results according to their relevance to the search query. Determining the relevance of search results to a query often involves the use of machine-learning algorithms (MLAs) that have been trained using multiple features to estimate various measures of relevance. This relevance determination can be seen as, at least in part, as a language comprehension problem, since the relevance of a document to a search query will have at least some relation to a semantic understanding of both the query and of the search results, even in instances in which the query and results share no common words, or in which the results are images, music, or other non-text results.

Recent developments in neural natural language processing include use of “transformer” machine learning models, as described in Vaswani et al., “Attention Is All You Need,” Advances in neural information processing systems, pages 5998-6008, 2017. A transformer is a deep learning model (i.e. an artificial neural network or other machine learning model having multiple layers) that uses an “attention” mechanism to assign greater significance to some portions of the input than to others. In natural language processing, this attention mechanism is used to provide context to the words in the input, so the same word in different contexts may have different meanings. Thus, transformer-based ML models are capable of considering semantics (that is, the meaning) of the words in a particular context, such as those of the search terms in a search query. Transformers are also capable of processing numerous words or natural language tokens in parallel, permitting use of parallelism in training.

Transformers have served as the basis for other advances in natural language processing, including pretrained systems, which may be pretrained using a large dataset, and then “refined” for use in specific applications. Examples of such systems include BERT (Bidirectional Encoder Representations from Transformers), as described in Devlin et al., “BERT: Pre-training of Deep Bidirectional Transformers for Language Understanding,” Proceedings of NAACL-HLT 2019, pages 4171-4186, 2019, and GPT (Generative Pre-trained Transformer), as described in Radford et al., “Improving Language Understanding by Generative Pre-Training,” 2018.

Broadly speaking, for the search ranking tasks, the transformers can be trained to determine relevance parameters of search results provided by a digital platform (such as a search engine, as an example) to a given user. For example, such relevance parameters may be represented by likelihood values of user interaction (such as a click) of the given user with the search results. More specifically, in response to the given user submitting a given search query, the digital platform can be configured to identify a respective set of digital documents (such as web documents, for example) responsive to the given search query. Further, both (i) the given search query and (ii) the respective set of digital documents can be fed to a transformer-based machine- learning (ML) model, trained based on specifically organized training data, for determining the rankings.

Although the transformer-based ML models have proved very practical in identifying relevant search results based on semantic relations thereof to the search query, it may be challenging for these models to “catch” lexical relations between the search query and the digital documents. In other words, due to assigning to some terms of the search query greater significance than to the others when applying the attention mechanism, the transformer-based ML models can disregard (or assign lower rankings to) digital documents including words that match exactly the terms of the search query.

For example, the user may submit, to the digital platform, the search query reading “Macarons recipe Cedric Grolet”; and the digital platform can be configured to identify a plurality of digital documents responsive to the search query. Further, the transformer-based ML model can be configured to rank the digital documents such that top search results in a search results page (SERP) of the digital platform would include digital documents (such as text documents, images, videos, and others) on information related to recipes of classical French desserts “macarons” alone and/or information related to the renowned French pastry chef Cedric Grolet alone. However, the transformer-based ML model may assign a comparatively low ranking to digital documents including information specifically on macaron recipes by Cedric Grolet, which may result in such digital documents not appearing on the SERP. This may affect user experience of the user from interacting with the digital platform.

Thus, there is the need in the art to consider both semantic and lexical aspects relations between the search query and the digital documents when ranking the digital documents. Certain prior art approaches have been proposed to tackle this technical problem.

An article entitled “COIL: Revisit Exact Lexical Match in Information Retrieval with Contextualized Inverted List”, authored by Gao et al., and published by Carnegie Mellon University, discloses a contextualized exact match retrieval architecture that brings semantic lexical matching using a Contextualized Inverted List (COIL). COIL scoring is based on overlapping query document tokens' contextualized representations. The architecture stores contextualized token representations in inverted lists, bringing together the efficiency of exact match and the representation power of deep language models.

U.S. Pat. No. 11,475,067-B2, issued on Oct. 18, 2022, assigned to Amazon Technologies Inc, and entitled “SYSTEMS, APPARATUSES, AND METHODS TO GENERATE SYNTHETIC QUERIES FROM CUSTOMER DATA FOR TRAINING OF DOCUMENT QUERYING MACHINE LEARNING MODELS”, discloses techniques for generation of synthetic queries from customer data for training of document querying machine learning (ML) models as a service. The service may receive one or more documents from a user, generate a set of question and answer pairs from the one or more documents from the user using a ML model trained to predict a question from an answer, and store the set of question and answer pairs generated from the one or more documents from the user. The question and answer pairs may be used to train another machine learning model, for example, a document ranking model, a passage ranking model, a question/answer model, or a frequently asked question (FAQ) model.

### SUMMARY

Developers of the present technology have appreciated that both semantic and lexical relations between the search queries and the digital documents to be ranked could be more effectively considered if the input to the transformer-based ML model included, aside from the search query and the digital documents to be ranked themselves, some sentences from the digital document candidates that have been determined as being lexically related to the search query.

More specifically, various aspects and embodiments of the present technology are directed to methods and systems including: (i) receiving the search query; (ii) identifying, from a search index of the digital platform, a plurality of digital document candidates responsive to the search query that are semantically related thereto; (iii) identifying, within the plurality of digital document candidates, a plurality of phrase candidates that are lexically related to the search query, that is, include at least one word which either matches exactly or is a grammatical derivative of one of the terms of the search query. Further, in accordance with certain non-limiting embodiments of the present technology, the search query and the so identified phrases lexically related thereto are fed to the transformer-based ML model, which has been trained to generate vector embeddings of input phrases, to generate: (i) a first vector embedding of the search query; and (ii) a second vector embedding of the plurality of phrases candidates.

Further, the methods and systems disclosed herein are directed to feeding, along with documents' and search query's vector embeddings, the so generated vector embeddings to a ranking ML model, which has been specifically pre-trained to determine rankings for digital documents based on these vector embeddings. Thus, when ranking digital documents for presentation thereof on the SERP of the digital platform, the present methods and systems may allow considering not only the semantic relations between the search query and the content of the digital documents responsive thereto but also the lexis of the search terms. By doing so, aside from the digital documents that are semantically (that is, by meaning) relevant to the search query, the SERP of the digital platform can include digital documents that are lexically relevant to the search query, that is, include words that match exactly or derive from at least one term of the search query. This may improve user experience of users interacting with the digital platform.

More specifically, in accordance with a first broad aspect of the present technology, there is provided a computer-implementable method for ranking digital documents at a digital platform. The method comprises: receiving a search query submitted by a user to the digital platform; generating a first vector embedding representative of the search query; identifying, in a search index of the digital platform, a plurality of digital document candidates that are responsive to the search query; retrieving, for each digital document candidate of the plurality of digital document candidates, a second vector embedding representative thereof, the second vector having been generated prior to the receiving of the search query; identifying, for a given one of the plurality of digital document candidates, at least one phrase candidate that is lexically related to at least one term of the search query; generating a third vector embedding representative of the at least one phrase candidate; based on the first, second, and third vector embeddings, determining, for the given one of the plurality of digital document candidates, a respective value of a ranking parameter, the ranking parameter being indicative of relevancy of the given of the plurality of digital document candidates to the search query; and ranking the plurality of digital document candidates based on respective values of the ranking parameter associated therewith.

In some implementations of the method, the identifying the plurality of digital document candidates comprises applying a ranking function.

In some implementations of the method, the ranking function is an Okapi BM25 ranking function.

In some implementations of the method, the identifying the at least one phrase candidate comprises: generating, for each phrase of a given one the plurality of digital document candidates, a respective phrase vector embedding; determining, in an embedding space, a distance value between the first vector embedding, representative of the search query, and the respective phrase vector embedding; ranking phrases of the plurality of digital document candidates in accordance with respective distance values associated with respective phrase embeddings, thereby generating a ranked list of phrases for the search query; and selecting, from the ranked list of phrases, a top predetermined number of phrases.

In some implementations of the method, the generating the respective phrase vector embedding comprises determining, for each term of the search query, a term frequency-inverse document frequency (TF-IDF) value, within a given one of the plurality of digital document candidates.

In some implementations of the method, the generating the respective phrase vector embedding comprises applying thereto a text embedding algorithm.

In some implementations of the method, the text embedding algorithm is a FastText word embedding algorithm.

In some implementations of the method, the determining comprises feeding the first, second, and third vector embeddings to a consolidated ML model, the consolidated ML model having been trained to determine the respective values of the ranking parameter for each one of a given plurality of digital documents based on vector embeddings of (i) a respective search query used for identifying the given plurality of digital documents; (ii) each one of the given plurality of digital documents responsive to the respective search query; and (iii) at least one phrase candidate identified in the given plurality of digital documents as being lexically related to at least one term of the respective search query.

In some implementations of the method, the method further comprises training the consolidated ML model by: generating a training set of data comprising a plurality of training digital objects, a given one of which comprises: (i) a training vector embedding of a training search query; (ii) training vector embeddings of a plurality of training digital documents candidates responsive to the training search query; and (ii) training phrase vector embedding of at least one training phrase candidate, identified in the plurality of training digital documents, that is lexically related to at least one term of the training search query; and (iv) a respective label for a given one of the plurality of training digital documents, the respective label being indicative of how relevant the given one of the plurality of training digital documents is to the training search query; feeding the plurality of training digital objects to the consolidated ML model; and minimizing, at each training iteration, a difference between a current training prediction of the consolidated ML model and the respective label.

In some implementations of the method, the respective label is provided by a human assessor.

In some implementations of the method, the respective label is generated by an ML model that has been pre-trained, based on human assessor-generated labels, to determine a degree of relevancy of the given digital document to the respective search query.

In some implementations of the method, the consolidated ML model comprises a Deep Semantic Similarity ML model.

In some implementations of the method, the retrieving the second vector embedding comprises receiving the second vector embedding from a second ML model that has been trained to generate vector embeddings of input digital documents.

In some implementations of the method, the method further comprises training the second ML model by feeding thereto the plurality of digital documents of the search index of the digital platform.

In some implementations of the method, prior to the determining, the method further comprises reducing a number of embeddings of each one of the first, second, and third vector embeddings.

In some implementations of the method, the generating the first, second, and third vector embeddings comprises applying a Transformer-based machine-learning (ML) model; and the reducing the number of embeddings comprises progressively truncating outputs of each intermediate layer of the Transformer-based ML model to a respective predetermined length of a given one of the first, second, and third vector embeddings.

In some implementations of the method, each one of the first, second, and third vector embeddings has a different respective predetermined length.

In some implementations of the method, the generating the first and third vector embeddings is conducted independently of generating the second vector embedding.

In some implementations of the method, the generating the first vector embedding representative of the search query and the generating the third vector embedding representative of the at least one phrase candidate comprises applying an ML model that has been trained to generate vector embeddings of input phrases.

In some implementations of the method, the method further comprises training the ML model by: generating a training set of data comprising a plurality of training digital objects, a given one of which comprises: (i) a training search query; and (ii) a plurality of training phrase candidates, identified in a respective plurality of training digital documents responsive to the training search query, that are lexically related to at least one term of the training search query; and feeding the plurality of training digital objects to the ML model.

In some implementations of the method, the ML model is a Transformer-based ML model.

In some implementations of the method, during the identifying the at least one phrase candidate that is lexically related to at least one term of the search query for the given one of the plurality of digital document candidates, the method further comprises using an unprocessed version of the given one of the plurality of digital document candidates.

In some implementations of the method, the unprocessed version is identified from the search index.

In accordance with a second broad aspect of the present technology, there is provided a server for ranking digital documents at a digital platform. The server comprises at least processor and at least one non-transitory computer-readable memory comprising executable instructions, which, when executed by the at least one processor, cause the server to: receive a search query submitted by a user to the digital platform; generate a first vector embedding representative of the search query; identify, in a search index of the digital platform, a plurality of digital document candidates that are responsive to the search query; retrieve, for each digital document candidate of the plurality of digital document candidates, a second vector embedding representative thereof, the second vector having been generated prior to the receiving of the search query; identify, for a given one of the plurality of digital document candidates, at least one phrase candidate that is lexically related to at least one term of the search query; generate a third vector embedding representative of the at least one phrase candidate; based on the first, second, and third vector embeddings, determine, for the given one of the plurality of digital document candidates, a respective value of a ranking parameter, the ranking parameter being indicative of relevancy of the given of the plurality of digital document candidates to the search query; and rank the plurality of digital document candidates based on respective values of the ranking parameter associated therewith.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus, information includes, but is not limited to audiovisual works (images, movies, sound records, presentations, etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have

been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims and accompanying drawings where:

FIG. 1 depicts a schematic diagram of an example computer system for implementing certain non-limiting embodiments of systems and/or methods of the present technology;

FIG. 2 depicts a networked computing environment suitable for ranking digital documents of a digital platform, in accordance with certain non-limiting embodiments of the present technology;

FIG. 3 depicts a block diagram of a machine-learning (ML) model architecture run by a server present in the networked computing environment of FIG. 2, in accordance with certain non-limiting embodiments of the present technology;

FIG. 4 depicts a schematic diagram of an example digital document including a plurality of phrase candidates identified, by the server present in the networked computing environment of FIG. 2, as being lexically related to a search query used for identifying the example digital document, in accordance with certain non-limiting embodiments of the present technology;

FIG. 5 depicts a schematic diagram of a first ML model, implemented based on the ML model architecture of FIG. 3, for generating vector embeddings of input phrases, in accordance with certain non-limiting embodiments of the present technology;

FIG. 6 depicts a schematic diagram of a second ML model, implemented based on the ML model architecture of FIG. 3, for generating vector embeddings of input digital documents, in accordance with certain non-limiting embodiments of the present technology;

FIG. 7 depicts a schematic diagram of a training process of a consolidated ML model that is configured to generate values of a ranking parameters for the digital documents based on the vector embeddings of the first and second ML models of FIGS. 5 and 6, respectively, in accordance with certain non-limiting embodiments of the present technology;

FIG. 8 depicts a schematic diagram of an in-use process of the consolidated ML model of FIG. 7, in accordance with certain non-limiting embodiments of the present technology; and

FIG. 9 depicts a flowchart diagram of a method of ranking the digital documents using the consolidated ML model of FIG. 8, in accordance with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit,” may be provided through the use of dedicated hardware as well as hardware capable of executing software in association with appropriate software. When provided by a processor, the functions may be provided by a single dedicated processor, by a single shared processor, and/or by a plurality of individual processors, some of which may be shared. In some embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random-access memory (RAM), and/or non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

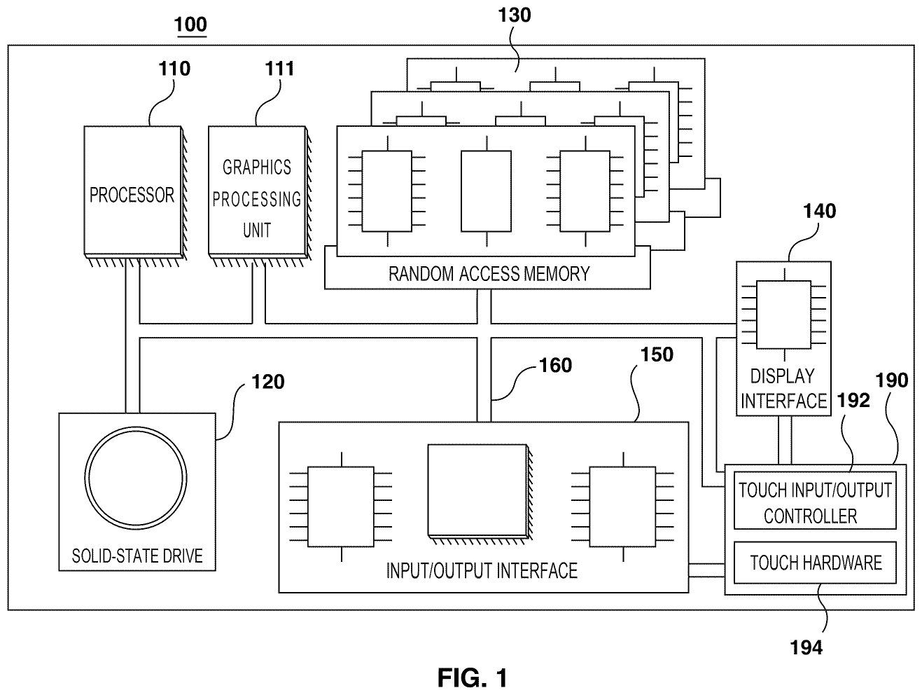

With reference to FIG. 1, there is depicted a computer system 100 suitable for use with some implementations of the present technology. The computer system 100 comprises various hardware components including one or more single or multi-core processors collectively represented by a processor 110, a graphics processing unit (GPU) 111, a solid-state drive 120, a random-access memory 130, a display interface 140, and an input/output interface 150.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In some non-limiting embodiments of the present technology, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of the display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the computer system 100 in addition to or instead of the touchscreen 190.

It is noted that some components of the computer system 100 can be omitted in some non-limiting embodiments of the present technology. For example, the touchscreen 190 can be omitted, especially (but not limited to) where the computer system is implemented as a server.

According to implementations of the present technology, the solid-state drive 120 stores program instructions suitable for being loaded into the random-access memory 130 and executed by the processor 110 and/or the GPU 111. For example, the program instructions may be part of a library or an application.

### Networked Computing Environment

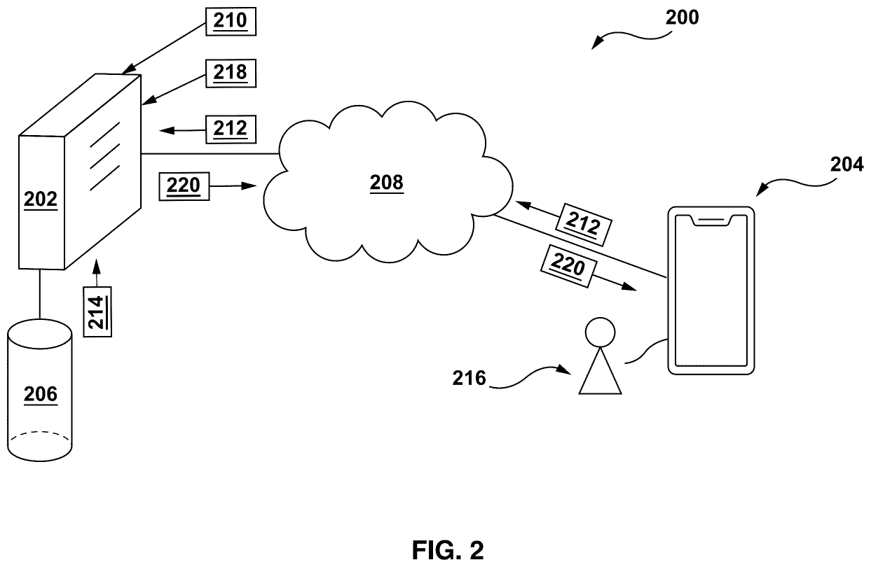

With reference to FIG. 2, there is depicted a schematic diagram of a networked computing environment 200 suitable for use with some non-limiting embodiments of the systems and/or methods of the present technology. The networked computing environment 200 comprises a server 202 communicatively coupled, via a communication network 208, to an electronic device 204. In some non-limiting embodiments of the present technology, the electronic device 204 may be associated with a user 216.

In some non-limiting embodiments of the present technology, the electronic device 204 may be any computer hardware that is capable of running a software appropriate to the relevant task at hand. In this regard, the electronic device 204 can comprise some or all of the components of the computer system 100 of FIG. 1. Some non-limiting examples of the electronic device 204 may include personal computers (desktops, laptops, netbooks, etc.), smartphones, and tablets. It should be expressly understood that, in some non-limiting embodiments of the present technology, the electronic device 204 may not be the only electronic device associated with the user 216; and the user 216 may also be associated with other electronic devices (not depicted in FIG. 2) coupled to the server 202 via the communication network 208 without departing from the scope of the present technology.

In some non-limiting embodiments of the present technology, the server 202 is implemented as a conventional computer server and may also comprise some or all of the components of the computer system 100 of FIG. 1. In a specific non-limiting example, the server 202 is implemented as a Dell™ PowerEdge™ Server running the Microsoft™ Windows Server™ operating system, but can also be implemented in any other suitable hardware, software, and/or firmware, or a combination thereof. In the depicted non-limiting embodiments of the present technology, the server 202 is a single server. In alternative non-limiting embodiments of the present technology (not depicted), the functionality of the server 202 may be distributed and may be implemented via multiple servers.

In some non-limiting embodiments of the present technology, the server 202 can be configured to host a digital platform 210. Broadly speaking, the digital platform 210 is a web resource configured to manage, that is, provide access to, present, and allow interactions with a plurality of various digital documents hosted by the digital platform 210. Generally speaking, types of digital documents hosted by the digital platform 210 depend on its particular implementation. For example, in some non-limiting embodiments of the present technology, the digital platform 210 is an audio streaming platform, such as a Spotify™ audio streaming platform, Yandex™0 Music™ audio streaming platform, and the like, and the plurality of digital documents can thus include various audio digital documents, such as audio tracks, audio books, podcasts, and the like. In another example where the digital platform 210 is a video hosting platform or a video streaming platform, such as a YouTube™ video hosting platform or a Netflix™ video streaming platform, for example, the plurality of digital documents can include various video digital documents, such as video clips, movies, news footages, and the like. In yet other example, where the digital platform is implemented as an online listing platform, such as a Yandex™ Market™ online listing platform, an Avito™ online listing platform, and the like, the plurality of digital documents can include advertisements of various items offered for sale, such as goods and services. In yet other example the digital platform 210 can be implemented as a as a search engine (such as a Google™ search engine, a Yandex™0 search engine, and the like), and the plurality of digital documents can include web document that can further include digital documents of all the above-mentioned types. It should be expressly understood that other implementations of the digital platform 210 as well as other respective types of digital documents hosted thereby are also envisioned.

Accordingly, to provide access to the plurality of digital documents to users of the digital platform 210, such as the user 216, the digital platform 210 can be configured to have a searching capability enabling the user 216 to submit search queries to the digital platform 210 (for example, via a dedicated user interface), in response to which the digital platform 210 can be configured to identify respective sets of digital documents.

According to certain non-limiting embodiments of the present technology, to store the plurality of digital documents potentially accessible via the communication network 208, the server 202 can be communicatively coupled to a search index database 206. In this regard, in those embodiments where the digital platform 210 comprises a streaming platform or an online listing platform, the search index database 206 could be preliminarily populated with indications of the plurality of digital documents by digital document providers, such as musicians, production studios, sellers of the items, respectively. However, in those embodiments where the digital platform 210 is implemented as a search engine, the search index database 206 could be preliminarily populated with the indications of the plurality of digital documents via the process known as “crawling”, which, for example, can be implemented, in some non-limiting embodiments of the present technology, also by the server 202. Further, although in the embodiments depicted in FIG. 2, the search index database 206 is depicted as a single entity, it should be expressly understood that in other non-limiting embodiments of the present technology, the functionality of the search index database 206 could be distributed among several databases. Also, in some non-limiting embodiments of the present technology, the search index database 206 could be accessed by the server 202 via the communication network 208, and not via a direct communication link (not separately labelled) as depicted in FIG. 2.

As will become apparent, in some non-limiting embodiments of the present technology, the search index database 206 can further be configured to store pre-generated respective vector embeddings, that is, numerical representations, of each digital document of the plurality of digital documents. In some non-limiting embodiments of the present technology, the respective vector-embeddings can be generated by a third-party server (not depicted) running, for example, a specifically trained machine-learning (ML) model. In some non-limiting embodiments of the present technology, the respective vector embeddings can be generated by the server 202, as will be described in detail below.

Thus, according to certain non-limiting embodiments of the present technology, the user 216, using the electronic device 204, may submit a search query 212 to the digital platform 210, and the digital platform 210 can be configured to identify, in the search index database 206, a set of digital documents 214 responsive to the search query 212.

According to certain non-limiting embodiments of the present technology, the server 202 can be configured to identify the set of digital documents 214 using an algebraic model configured to estimate a relevance of given one of the plurality of digital documents hosed by the digital platform 210 to the search query 212. In some non-limiting embodiments of the present technology, the algebraic model can comprise a ranking function. For example, the ranking function can be implemented based on a bags-of-words model, and can comprise an Okapi BM25 ranking function. However, it should be noted that it is not limited how the server 202 is configured to identify the set of digital documents 214. For example, in other non-limiting embodiments of the present technology, the server 202 can be configured to apply machine-learning (ML)-based approaches, such as decision tree-based ML models, to identify the set of digital documents 214

Further, once the server 214 has identified the set of digital documents 214, to aid the user 216 of the digital platform 210 in navigating through the set of digital documents 214, the server 202 can be configured to rank digital documents of the set of digital documents 214, for example, according to their respective degrees of relevance to the search query 212. By doing so, the server 202 can be configured to generate a ranked set of digital documents 220.

Developers of the present technology have realized that user satisfaction of the user 216 from the set of digital documents 214 can increase if the rankings for the set of digital documents 214 were determined based on both lexical and semantic relations between the digital documents of the set of digital documents 214 and terms of the search query 212.

In the context of the present technology, the term “semantic relations” between a given term of the search query 212 and a given digital document of the set of digital documents 214 denotes how the given digital document is responsive to the semantics of the given term of the search query 212, that is, to the meaning thereof. More specifically, the semantic relations between the given term and the given digital document can be defined by whether the given digital document includes words that are from the same semantic field as the given term of the search query 212, that is, from the same lexical set of words grouped semantically that refers to a respective subject. For example, the semantic field of “motion” may include the words “run”, “walk”, “fly”, “ride”, “stroll”, “swiftly”, and others, including various derivatives thereof in all parts of speech. A specific example of a semantic relation between the given digital document and the given term of the search query 212 may be a presence of synonyms or antonyms of the given term in the given digital document. Also, the term “semantic relations” should not be construed as being limited by the semantic relations between words. For example, the given digital document including an image or a video clip of a cat is considered semantically related to the given term of the search query 212 reading “cat” or other terms from the same semantic field, such as “cat litter”, “catnip”, “kitten”, and vice versa: images or video clips depicting these entities are considered semantically related to the word “cat”. In another example, an audio feed of meowing of a cat is also considered semantically related to the word “cat”.

Further, in the context of the present specification, the term “lexical relations” between the given term of the search query 212 and the given digital document denotes how the given digital document is responsive to the lexis of the given term of the search query 212, that is, to a linguistic form thereof that is registered in a dictionary. More specifically, the semantic relations between the given term and the given digital document can be defined by at least one of: (i) whether the given digital document includes words that exactly match the given term of the search query 212; (ii) whether the given digital document includes one or more grammatical forms of the given term of the search query 212, such as those that vary in categories of singular/plural and case (or otherwise, declination, for example, cat—cats—cat's) for nouns and categories of person, singular/plural, and tense (or otherwise, conjugation, for example, sleep—sleeps—slept)—for verbs; and (iii) whether the given digital document includes any same-root words derived from the given term of the search query 212 within a given part of speech, such as action—activity—act (noun).

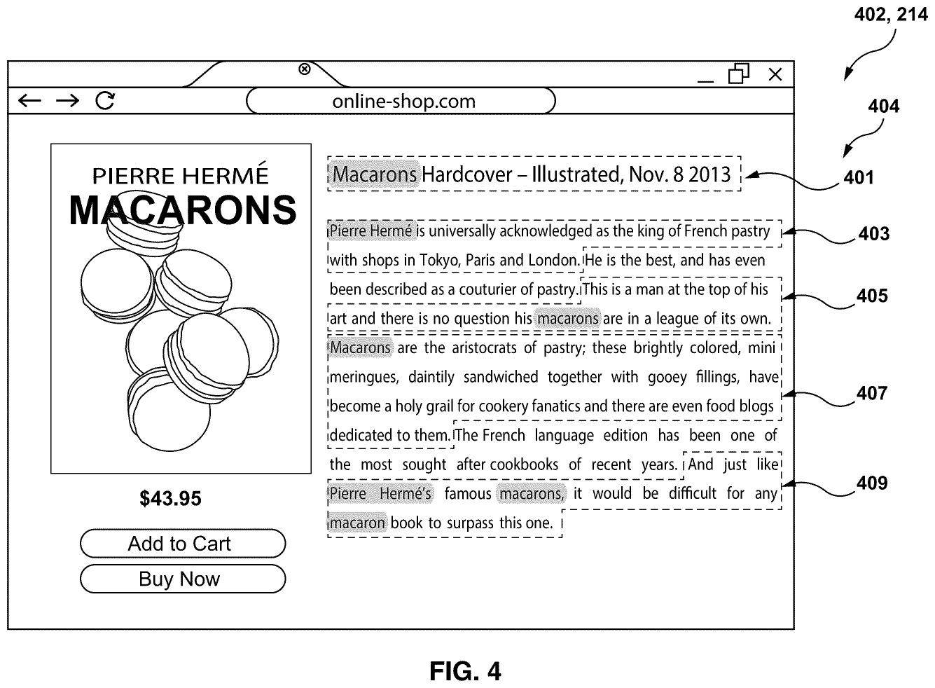

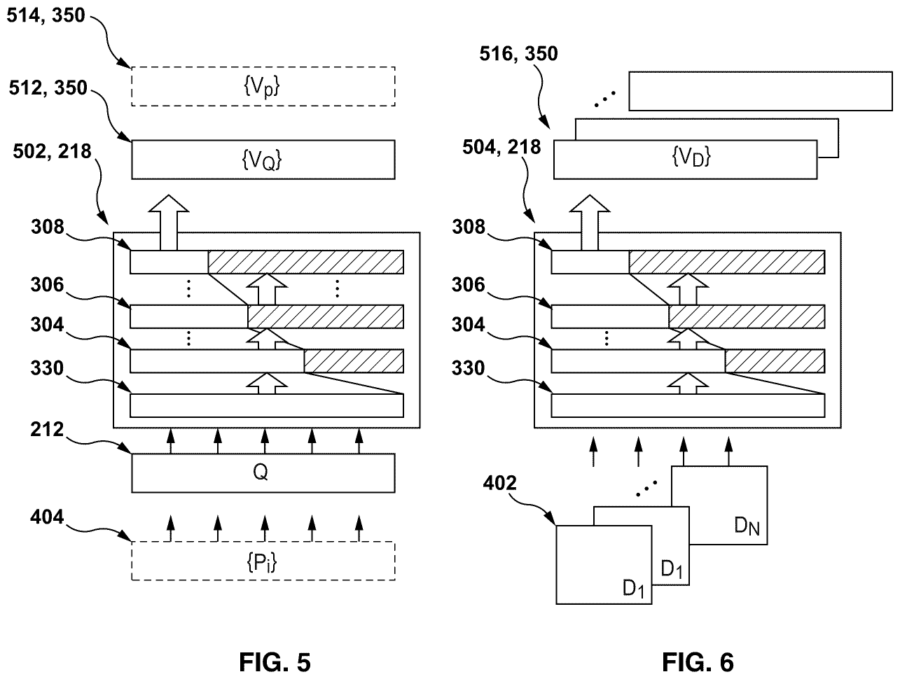

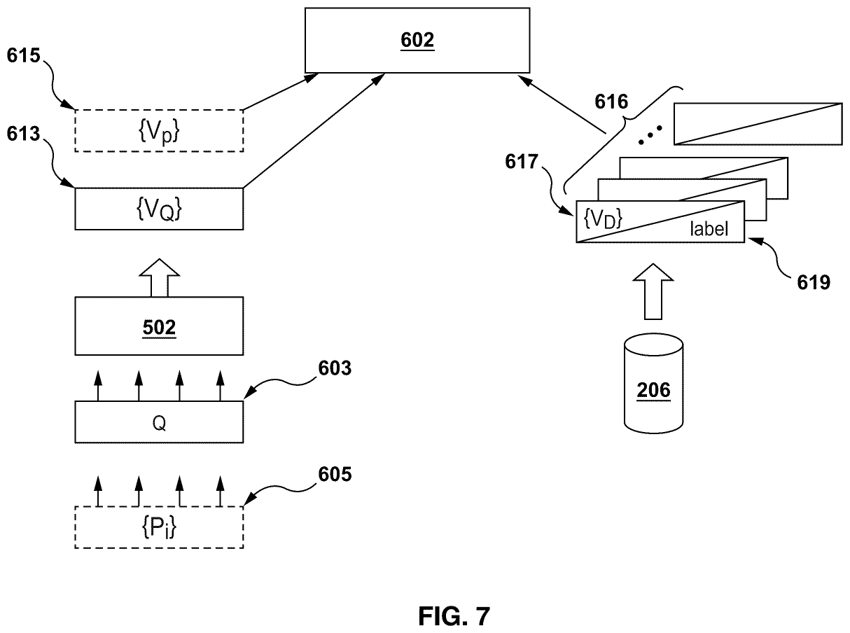

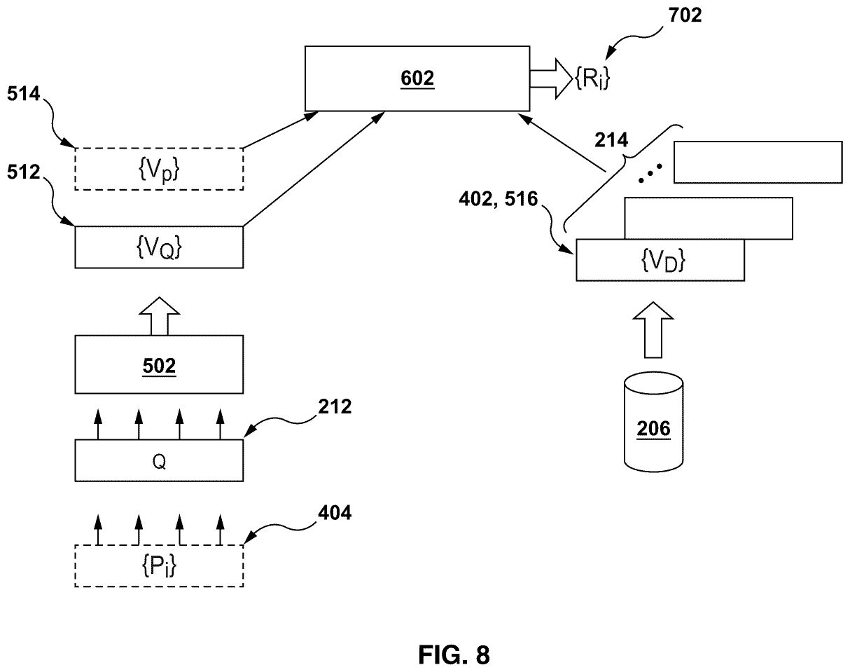

In some non-limiting embodiments of the present technology, to determine how relevant the given digital document of the set of digital documents 214 to the search query 212 is in terms of semantics and lexis, according to some non-limiting embodiments of the present technology, the server 202 can be configured to train and further apply a machine-learning algorithm (MLA) 218 including a consolidated ML model 602, training and using which is described in detail below with reference to FIGS. 7 and 8. More specifically, according to certain non-limiting embodiments of the present technology, the consolidated ML model 602 can be configured to determine respective values of the ranking parameter for each digital document of the set of digital documents 214 based on how relevant the given digital document, in terms of lexis and semantics thereof, to the search query 212. As will become apparent from the description provided hereinbelow, to do so, the consolidated ML model 602 can be configured to receive: (i) a first vector embedding of the search query 212, such as a search query vector embedding 512 of FIG. 5; (ii) the second vector embedding of the given digital document, such as a document vector embedding 516 of an example digital document 402 as depicted in FIG. 6; and (iii) a third vector embedding of at least one phrase candidate from the set of digital documents 214 which is lexically related to at least one term of the search query 212, such as a phrase vector embedding 514 depicted in FIG. 5. How the server 202 can be configured to obtain the first, second, and third vector embeddings for feeding thereof to the consolidated ML model 602, will be described in detail below with reference to FIGS. 4 to 6.

In some non-limiting embodiments of the present technology, the consolidated ML model 602 could be implemented based on a neural network (NN) architecture. For example, in these embodiments, the consolidated ML model 602 can be a Deep Semantic Similarity Model (DSSM)-based ML model, a long short-term memory (LSTM) NN-based ML model, or a Transformer-based ML model.

However, it should be expressly understood that other types of ML models can be used for implementing the consolidated ML model 602, such as, without limitation: decision tree-based ML model, gradient boosted decision tree-based ML model, association rule learning based ML model, inductive logic programming based ML model, support vector machines based ML model, clustering based ML model, Bayesian networks, reinforcement learning based ML model, representation learning based ML model, similarity and metric learning based ML model, sparse dictionary learning based ML model, genetic algorithms based ML model, and the like.

Further, based on the so determined respective values of the ranking parameter, the server 202 can be configured to rank the digital documents within the set of digital documents 214, thereby generating the ranked set of digital documents 220. By doing so, the server 202 can be configured to provide the user 216 with more relevant digital documents, which may help improve the satisfaction of the user 216 from interacting with the digital platform 210.

Generally speaking, the server 202 can be said to be executing two respective processes in respect of the consolidated ML model 602 of the MLA 218. A first process of the two processes is a training process, where the server 202 is configured to train the consolidated ML model 602, based on a training set of data, to determine the respective values of the ranking parameter for each digital document of the set of digital documents 214. The training process will be described below with reference to FIG. 7. A second process is an in-use process, where the server 202 executes the consolidated ML model 602 for ranking the digital documents in the set of digital documents 214, which will be described further below with reference to FIG. 8, in accordance with certain non-limiting embodiments of the present technology.

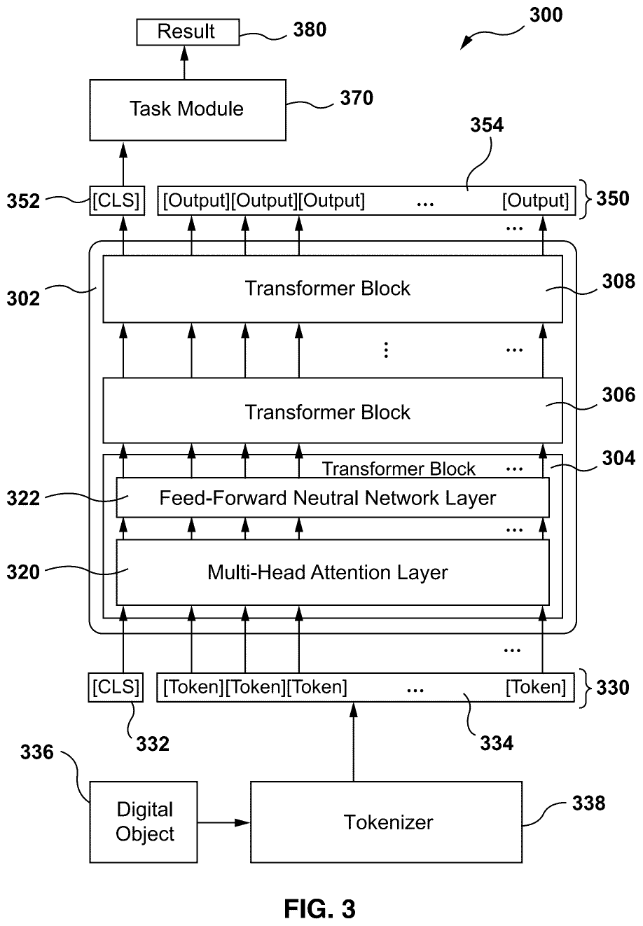

An example ML model architecture that can be used for implementing the MLA 218 including the consolidated ML model 602 will be described immediately below with reference to FIG. 3.

### Communication Network

In some non-limiting embodiments of the present technology, the communication network 208 is the Internet. In alternative non-limiting embodiments of the present technology, the communication network 208 can be implemented as any suitable local area network (LAN), wide area network (WAN), a private communication network or the like. It should be expressly understood that implementations for the communication network are for illustration purposes only. How a respective communication link (not separately numbered) between each one of the server 202 and the electronic device 204 and the communication network 208 is implemented will depend, inter alia, on how each one of the server 202 and the electronic device 204 is implemented. Merely as an example and not as a limitation, in those embodiments of the present technology where the electronic device 204 is implemented as a wireless communication device such as a smartphone, the communication link can be implemented as a wireless communication link. Examples of wireless communication links include, but are not limited to, a 3G communication network link, a 4G communication network link, and the like. The communication network 208 may also use a wireless connection with the server 202.

### Machine Learning Model Architecture

With reference to FIG. 3, there is depicted a block diagram of a ML model architecture 300 used for implementing the MLA 218, in accordance with certain non-limiting embodiments of the present technology. As noted above, in some non-limiting embodiments of the present technology, the ML model architecture 300 can be based on the BERT machine learning model, as described, for example, in the Devlin et al. paper referenced above. Like BERT, the ML model architecture 300 includes a transformer stack 302 of transformer blocks, including, for example, transformer blocks 304, 306, and 308.

Each of the transformer blocks 304, 306, and 308 includes a transformer encoder block, as described, for example, in the Vaswani et al. paper, referenced above. Each of the transformer blocks 304, 306, and 308 includes a multi-head attention layer 320 (shown only in the transformer block 304 here, for purposes of illustration) and a feed-forward neural network layer 322 (also shown only in transformer block 304, for purposes of illustration). The transformer blocks 304, 306, and 308 are generally the same in structure, but (after training) will have different weights. In the multi-head attention layer 320, there are dependencies between the inputs to the transformer block, which may be used, for example, to provide context information for each input based on each other input to the transformer block. The feed-forward neural network layer 322 generally lacks these dependencies, so the inputs to the feed-forward neural network layer 322 may be processed in parallel. It will be understood that although only three transformer blocks (transformer blocks 304, 306, and 308) are shown in FIG. 3, in actual implementations of the disclosed technology, there may be many more such transformer blocks in the transformer stack 302. For example, some implementations may use 12 transformer blocks in the transformer stack 302.

Inputs 330 to the transformer stack 302 include tokens, such as a [CLS] token 332, and tokens 334. The tokens 334 may, for example represent words or portions of words. The [CLS] token 332 is used as a representation for classification for the entire set of tokens 334. Each of the tokens 334 and the [CLS] token 332 is represented by a vector. In some implementations, these vectors may each be, for example, 768 floating point values in length. It will be understood that a variety of compression techniques may be used to effectively reduce sizes (dimensionality) of the vectors.

In some non-limiting embodiments of the present technology, there may be a fixed number of the tokens 334 that are used as the inputs 330 to the transformer stack 302. For example, in some non-limiting embodiments of the present technology, 1024 tokens may be used, while in other implementations, the transformer stack 302 may be configured to take 512 tokens (aside from the [CLS] token 332). Those of the inputs 330 that are shorter than this fixed number of tokens 334 may be extended to the fixed length by adding padding tokens, as an example.

In some implementations, the inputs 330 may be generated from a training digital object 336 using a tokenizer 338. The architecture of the tokenizer 338 will generally depend on the training digital object 336 that serve as input to the tokenizer 338. For example, in some non-limiting embodiments of the present technology, the tokenizer 338 may involve use of known encoding techniques, such as byte-pair encoding, as well as use of pre-trained neural networks for generating the inputs 330.

In some non-limiting embodiments of the present technology, the tokenizer 338 can be implemented based on a WordPiece byte-pair encoding scheme, such as that used in BERT learning models with a sufficiently large vocabulary size. For example, in some non-limiting embodiments of the present technology, the vocabulary size may be approximately 120,000 tokens. In some non-limiting embodiments of the present technology, before applying the tokenizer 338, the inputs 330 can be preprocessed. For example, all words of the inputs 330 can be converted lowercase, and Unicode NFC normalization can further be performed. The WordPiece byte-pair encoding scheme that may be used in some implementations to build the token vocabulary is described, for example, in Rico Sennrich et al., “Neural Machine Translation of Rare Words with Subword Units”, Proceedings of the 54th Annual Meeting of the Association for Computational Linguistics (Volume 1: Long Papers), pages 1715-1725, 2016.

Also, in some non-limiting embodiments of the present technology, additional to or instead of using the tokenizer 338, to generate the inputs 330, the server 202 can be configured to use an embedding algorithm. Broadly speaking, the embedding algorithm can be configured to convert input data, such as the digital object 336, into a numerical vector in a given embedding space. As such, a particular implementation of the embedding algorithm generally depends on a data type of the digital object 336. For example, in those non-limiting embodiments of the present technology where the digital object 336 includes one of a past query and a plurality of past phrase candidates associated therewith, as will be described below, the embedding algorithm can comprise a text embedding algorithm.

In some non-limiting embodiments of the present technology, the text embedding algorithm can include, without limitation, one of a Word2Vec text embedding algorithm, a GloVe text embedding algorithm, a FastText text embedding algorithm, and the like, which the server 202 can be configured to use to generate the inputs 330 to the ML model architecture 300.

In another example, in those non-limiting embodiments of the present technology, where the digital object 336 includes an audio feed, the embedding algorithm can be implemented as an acoustic embedding algorithm. According to certain non-limiting embodiments of the present technology, the acoustic embedding algorithm can comprise, including, without limitation, a Seq2Seq Autoencoder acoustic embedding algorithm, a Convolutional Vector Regression acoustic embedding algorithm, a Letter-ngram acoustic embedding algorithm, an LSTM-based acoustic embedding algorithm, and the like.

In yet other example, in those non-limiting embodiments of the present technology, where the digital object 336 includes an image, the embedding algorithm can be implemented as an image embedding algorithm. Various examples of the image embedding algorithm include those implemented based on deep neural networks, such as convolutional neural networks, including, without limitation, an InceptionV3 image embedding algorithm, a SqueezeNet image embedding algorithm, and a DeepLoc image embedding algorithm.

In additional non-limiting embodiments of the present technology, after using the tokenizer 338, the generating the inputs 330 can further include applying, by the server 202, a positional embedding algorithm (not depicted) configured to register positional information within portions of the input training digital object 336. For example, if the input training digital object 336 includes a text sentence, the positional embedding algorithm can be configured to generate a vector indicative of positional information amongst words in that text sentence. It is not limited how the positional embedding algorithm is implemented; and may include, without limitation, a sinusoid positional embedding algorithm, a frame stacking positional embedding algorithm, and a convolutional positional embedding algorithm, as an example.

Outputs 350 of the transformer stack 302 include a [CLS] output 352, and a vector of outputs 354, including a respective output value for each of the tokens 334 in the inputs 330 to the transformer stack 302. The outputs 350 may then be sent to a task module 370. In some implementations, as is depicted in FIG. 3, the task module 370 uses only the [CLS] output 352, which serves as a representation of the entire vector of the outputs 354. This can be most useful when the task module 370 is being used as a classifier, or to output a label or value that characterizes the entire input training digital object 336, such as generating a relevance score-for example, the respective value of the ranking parameter for the given digital document of the set of digital documents 214, as described above.

In some non-limiting embodiments of the present technology (not depicted in FIG. 3) all or some values of the vector of the outputs 354, and possibly the [CLS] output 352 may serve as inputs to the task module 370. This can be most useful when the task module 370 is being used to generate labels or values for each one of the tokens 334 of the inputs 330, such as for prediction of a masked or missing token or for named entity recognition. In some non-limiting embodiments of the present technology, the task module 370 may include a feed-forward neural network (not depicted) that generates a task-specific result 380, such as a relevance score or click probability. Other models could also be used in the task module 370. For example, the task module 370 may itself be a transformer or other form of neural network. Additionally, the task-specific result 380 may serve as an input to other models, such as a CatBoost model, as described in Dorogush et al., “CatBoost: gradient boosting with categorical features support”, NIPS 2017.

It will be understood that the architecture of the ML model architecture 300 described above with reference to FIG. 3 has been simplified for ease of clarity and understanding of certain non-limiting embodiments of the present technology. For example, in an actual implementation of the ML model architecture 300, each of the transformer blocks 304, 306, and 308 may also include layer normalization operations, the task module 370 may include a softmax normalization function, and so on. One of ordinary skill in the art would understand that these operations are commonly used in neural networks and deep learning models such as the ML model architecture 300.

### Generating Vector Embeddings

As mentioned hereinabove, the lexical relations between the given digital document and the search query 212 can be defined by whether the given digital document includes at least one word that has a same linguistic form as at least one term of the search query 212.

To that end, for ranking each digital document in the set of digital documents 214 using the consolidated ML model 602, in some non-limiting embodiments of the present technology, first, the server 202 can be configured to identify, in each digital document in the set of digital documents 214, a respective plurality of phrase candidates that are lexically related to the at least one term of the search query 212. In other words, as mentioned above, a given one of the respective plurality of phrase candidates can include words that are at least one of: (i) exactly match the at least one term of the search query; (ii) comprise one or more grammatical forms of the at least one term of the search query 212; and (iii) comprise one or more same-root words of the at least one term of the search query 212 within a same part of speech.

With reference to FIG. 4, there is depicted a schematic diagram of an example digital document 402 of the set of digital documents 214 including a plurality of phrase candidates 404, in accordance with certain non-limiting embodiments of the present technology.

Let it be assumed that, in the example of FIG. 4, the digital platform 210 comprises an online listing platform that the user 216 accessed by submitting a respective URL of the online listing platform to an address bar of a browser application of the electronic device 204. Further, the user 216 may submit, to the digital platform 210, the search query 212 reading “Macaron Recipe Pierre Herme”. Further, using, for example, the algebraic model mentioned above, the server 202 can be configured to identify, in the search index database 206 storing the plurality of digital documents, the set of digital documents 214 responsive to this search query. Further, in the example digital document 402 of the set of digital documents 214, the server 202 can be configured to identify the plurality of phrase candidates 404 that include at least one word lexically related to at least one term of the search query 212.

According to certain non-limiting embodiments of the present technology, the server 202 can be configured to identify, in the example digital document 402, the plurality of phrase candidates 404 by determining a respective value of a similarity metric between the search query 212 and each phrase of the example digital document 402. In some non-limiting embodiments of the present technology, the similarity metric is indicated by a distance between vectors representative of the search query 212 and a given phrase of the example digital document 402 in a given embedding space. In this regard, for example, the similarity metric can include a cosine similarity metric. In some non-limiting embodiments of the present technology, the server 202 can be configured to determine certain phrases of the example digital document 402 as being phrase candidates for inclusion in the plurality of phrase candidates 404 if their respective values of the similarity metric to the search query 212 is greater than a predetermined similarity threshold. In other non-limiting embodiments of the present technology, the server 202 can be configured to: (i) rank the phases of the example digital document 402 according to their values of the similarity metric; and (ii) and select a top N number of phrases for inclusion in the plurality of phrase candidates 404.

Further, it is not limited how the server 202 can be configured to generate the vectors representative of the search query 212 and each phrase of the example digital document 402. For example, in some non-limiting embodiments of the present technology, the server 202 can be configured to generate the respective vectors by determining, for each term of the search query 212, a term frequency-inverse document frequency (TF-IDF) value thereof in each phrase of the example digital document 402. However, in other non-limiting embodiments of the present technology, the server 202 can be configured to apply, to the search query and each phrase of the example digital document 402, one of text-embedding algorithms mentioned above.

Thus, for example, the server 202 can be configured to identify a first phrase candidate 401 as it exactly matches search terms “Pierre Herme” (highlighted) of the search query 212. Further, the server 202 can be configured to identify a second phrase candidate 403 as it includes a plural form of a search term “Macaron” of the search query 212. Similarly, the server 202 can be configured to identify a third and fourth phrase candidates 405, 407. Finally, the server 202 can be configured to identify a fifth phrase candidate 409 as it includes a possessive form of the search term “Pierre Herme”, the plural form of the search term “Macaron”, and word that exactly matches the search term “Macaron”.

In some non-limiting embodiments of the present technology, for further use in ranking the set of digital documents 214, the plurality of phrase candidates 404 can include a predetermined number of phrase candidates, such as 3, 5, or 10, 100, 147000, as an example. In these embodiments, for inclusion in the plurality of phrase candidates 404, the server 202 can be configured to select, from the example digital document 402, only those phrase candidates that have the greatest number of lexically related words to the terms of the search query 212. For example, of the predetermined number of phrase candidates equals 3, the server 202 can be configured to include, in the plurality of phrase candidates 404: the fifth phrase candidate 409, the second phrase candidate 403, and one of the first, third, and fourth phase candidates 401, 405, and 407.

In some non-limiting embodiments of the present technology, a given one of the plurality of phrase candidates 404 can include no fewer than a predetermined target number of words that are lexically related to the at least one term of the search query 212. More specifically, in these embodiments, if the predetermined target number is, for example, 2, the server 202 can be configured to disregard all the phrase candidates in the plurality of phrase candidates 404 except for the second and fifth phrase candidate 403, 409.

Thus, by using a similar approach described above with respect to the example digital document 402, the server 202 can be configured to analyze other ones of the set of digital documents 214 to identify phrase candidates for inclusion in the plurality of phrase candidates 404. In some non-limiting embodiments of the present technology, the server 202 can be configured each and every digital document of the set of digital documents 214. In other non-limiting embodiments of the present technology, the server 202 can be configured to analyze only a portion of the set of digital documents 214 for identifying the phrase candidates for the plurality of phrase candidates 404. The server 202 can be configured to identify such a portion of the set of digital documents 214 as a top-N digital documents that are most responsive to the search query 212.

In yet other non-limiting embodiments of the present technology, to determine the plurality of phrase candidates 404, the server 202 can be configured to: (i) determine, for each phrase, within the set of digital document 214, a respective value of the similarity metric with the search query 212, as mentioned above; (ii) rank the phrases according to the respective values of the similarity metric; and (iii) select a top-N number (such as 3, 5, or 20, for example) of phrases from the set of digital documents 214 for inclusion in the plurality of phrase candidates 404.

Thus, according to certain non-limiting embodiments of the present technology, the server 202 can be configured to extract the information of the lexical relations between the search query 212 and the set of digital documents 214 from an unprocessed versions thereof, as they have been stored in the search index database 206 upon population thereof, via, for example, crawling the communication network 208 by the server 202 as mentioned above.

Further, in some non-limiting embodiments of the present technology, to feed the plurality of phrase candidates 404 and the search query 212 to the consolidated ML model 602, the server 202 can be configured to determine vector embeddings thereof. In some non-limiting embodiments of the present technology, the server 202 can be configured to determine the vector embeddings the plurality of phrase candidates 404 and the search query 212 using one of the example text embedding algorithms mentioned above with respect to the description of the ML model architecture 300. However, in other non-limiting embodiments of the present technology, the server 202 can be configured to determine these vector embeddings using a specifically trained ML model.

To that end, the MLA 218 can include a first model 502, schematically depicted in FIG. 5, in accordance with certain non-limiting embodiments of the present technology. According to certain non-limiting embodiments of the present technology, the first ML model 502 can be implemented as a deep neural network, such as an LSTM neural network or a recurrent neural network. In some non-limiting embodiments of the present technology, the first ML model 502 can be implemented as a Transformer-based ML model. To that end, the first ML model 502 can include some or all the components of the ML model architecture 300 described above.

According to certain non-limiting embodiments of the present technology, the first ML model 502 can be configured to generate vector embeddings of input phrases. For example, the first ML model 502 can be configured to: (i) receive the search query 212 to generate a search query vector embedding 512; and (ii) receive the plurality of phrase candidates 404 to generate a phrase vector embedding 514.

To train the first ML model 502 to generate the vector embeddings of the input phrases, the server 202 can be configured to generate a first training set of data comprising a first plurality of training digital objects, a given one of which includes a given training phrase. Akin to the search query 212 and the plurality of phrase candidates 404, in some non-limiting embodiments of the present technology, the given training phrase can include one of a training search query (such as one of past queries submitted by users of the digital platform 210) and a training plurality of phrase candidates, identified similarly to the plurality of phrase candidates 404 for the search query 212. However, in other non-limiting embodiments of the present technology, the given training phrase can be any other phrase, which the server 202 can be configured to mine, for example, from the entire plurality of digital documents hosted by the digital platform 210. In another example, the server 202 can be configured to mine training phases for training the first ML model 502 from other resources of the communication network 208 including any textual information.

Further, the server 202 can be configured to feed each training digital object of the first plurality of training digital objects to the first ML model 502, thereby training the first ML model 502 to generate the vector embeddings of the input phrases. As mentioned hereinabove, with respect to the description of the ML model architecture 300, the server 202 can be configured to: (i) feed the given training phrase to the tokenizer 338, to generate the inputs 330; (ii) feed the inputs 330 to the transformer blocks 304, 306, and 308 to cause the generation of the outputs 350 that include a numerical representation of the given training phrase considering the context of words within the given training phrase. In other words, the outputs 350 of the first ML model 502 may include a vector embedding of the given training phrase which includes cumulative semantics of the given training phrase. Thus, by feeding the first plurality of training digital objects to the first ML model 502, the server 202 can be configured to determine weights of the transformer blocks 304, 306, and 308, thereby training the first ML model 502 to generate the vector embeddings of the input phrases, such as the search query 212 and the plurality of phrase candidates 404.

Also, as best shown in FIG. 5, according to certain non-limiting embodiments of the present technology, the server 202 can be configured to reduce a number of embeddings (that is, a number of values in the vector of outputs 354) in the outputs 350 of the first ML model 502. To do so, in some non-limiting embodiments of the present technology, the server 202 can be configured to truncate values only of the outputs 350 to a desired predetermined length. However, in other non-limiting embodiments of the present technology, the server 202 can be configured to reduce the number of embeddings of the outputs 350 of the first ML model 502 by progressively truncating values of outputs of intermediate layers thereof, that is, each one of the transformer blocks 304, 306, and 308, until the desired predetermined length of the outputs 350 is attained. In various non-limiting embodiments of the present technology, the server 202 can be configured to select the desired predetermined length of the outputs 350 for the first ML model 502, as well as truncated lengths of the outputs of the transformer blocks 304, 306, and 308 based on a trade-off between a speed and quality of generating the outputs 350 for further use as one of the inputs to the consolidated ML model 602. For example, the desired predetermined length of the outputs 350 after the truncation can be 8, 16, or 32 values of the respective vector embeddings.

In some non-limiting embodiments of the present technology, the server 202 can be configured to reduce the number of embeddings in the outputs 350 of the first ML model 502 differently for different vector embeddings. In other words, for generating the search query vector embedding 512, the server 202 can be configured to cause the first ML model 502 to truncate the values of the outputs 350 to a first desired predetermined length, which can be 8 values, for example. By contrast, for generating the phrase vector embedding 514, the server 202 can be configured to cause the first ML model 502 to truncate the values of the outputs 350 to a second desired predetermined length, which can be 16 values, for example.

Thus, the server 202 can be configured to use the first ML model 502 for generating vector embeddings of search queries and the respective pluralities of phrase candidates, based on which the consolidated ML model 602 can further be trained and used to rank digital documents, such as the set of digital documents 214, considering the lexical relations thereof with the search query 212, as will be described below.

Further, for determining the semantic relations between the given digital document of the set of digital documents 214 and the search query 212 using the consolidated ML model 602, according to certain non-limiting embodiments of the present technology, the server 202 can be configured to obtain the respective document vector embedding of the given digital document.

As mentioned hereinabove, in some non-limiting embodiments of the present technology, the respective document vector embedding of the given digital document can be pre-generated by a third-party server and stored in the search index database 206 in association with the respective digital documents of the digital platform 210. However, in some non-limiting embodiments of the present technology, the server 202 itself can be configured to generate the respective document vector embedding. In some non-limiting embodiments of the present technology, the server 202 can be configured to generate the respective document embedding, depending on a type of the given digital document (such as textual, audio, video, and others), using one of various implementations of the embedding algorithm mentioned above with respect to the description of the ML model architecture 300.

In other non-limiting embodiments of the present technology, for generating document vector embeddings, the MLA 218 hosted by the server 202 can include a second ML model 504, schematically depicted in FIG. 6, in accordance with certain non-limiting embodiments of the present technology.

According to certain non-limiting embodiments of the present technology, akin to the first ML model 502, the second ML model 504 can be implemented as a deep neural network, such as a Transformer-based ML model. To that end, the second ML model 504 can include some or all the components of the ML model architecture 300 described above.

For example, the second ML model 504 can be configured to (i) receive the example digital document 402; and (ii) generate a document vector embedding 516 that would consider context information of elements within the example digital document 402. To do so, in some non-limiting embodiments of the present technology, first, the server 202 can be configured to train the second ML model to generate the vector embeddings of various digital documents.

To that end, according to certain non-limiting embodiments of the present technology, the server 202 can be configured to: (i) generate a second training set of data including a second plurality of training digital objects, each one of which includes a respective one of the plurality of digital documents hosted by the digital platform 210; (ii) feed each one of the second plurality of training digital objects to the tokenizer 338 to generate the inputs 330 to the second ML model 504; (ii) feed the inputs 330 to the transformer blocks 304, 306, and 308 to cause the generation of the outputs 350 that include a numerical representation of the given digital document. Thus, by feeding each and every digital document of the plurality of digital documents of the digital platform 210, the server 210 can be configured to determine the weights of the transformer blocks 304, 306, and 308 of the second ML model 502, thereby training the second ML model 504 to generate the document vector embeddings, such as the document vector embedding 516 of the example digital embedding 402.

As it can be appreciated, when using the second ML model 504 for ranking the set of digital documents 214, the generating the vector embeddings for each one of the set of digital documents 214 in real time can be a very resource-intensive task for the server 202. Therefore, in some non-limiting embodiments of the present technology, the server 202 can be configured to: (i) cause the second ML model 504 to generate the document vector embeddings of the plurality of digital documents in advance and store them in association with respective digital documents, for example, in the search index database 206; and (ii) use the so generated respective document embedding for the given digital document of the set of digital documents 214 as an input to the consolidated ML model 602 when necessary, as will be described below. This may help save computational resources of the server 202 in real time.

Also, akin to the case with the first ML model 502, in some non-limiting embodiments of the present technology, the server 202 can be configured to cause the second ML model 504 to reduce a number of embeddings of the outputs 350 thereof, using one of the truncation approaches described above. It should be noted that the resulting length of the document vector embedding 516 can be either the same or different from those of the search query and phrase vector embeddings 512, 514.

Thus, the server 202 can be configured to generate document vector embeddings, based on which the server 202 can further be configured to train and use the consolidated ML model 602 to rank the set of digital documents 214 considering how the given digital document of the set of digital documents 214 is semantically related to the search query 212.

In other words, after obtaining the vector embeddings for (1) search queries; (2) respective pluralities of phrase candidates that are lexically related to the search queries; and (3) digital documents—such as via training and using the first and second ML models 502, 504, the server 202 can be configured to train the consolidated ML model 602 to rank the digital documents based on both lexical and semantic relations thereof with the respective search queries, as will be described immediately below.

### Training Process

With reference to FIG. 7, there is depicted a schematic diagram for training the consolidated ML model 602 to rank the set of digital documents 214, in accordance with certain non-limiting embodiments of the present technology. As mentioned hereinabove, in some non-limiting embodiments of the present technology, the consolidated ML model 602 can be implemented as a DSSM-based ML model. In other non-limiting embodiments of the present technology, the consolidated ML model 602 can be a Transformer-based ML model. In these embodiments, the consolidated ML model 602 can include some or all the components of the ML model architecture 300 described above.

According to certain non-limiting embodiments of the present technology, to train the consolidated ML model 602 to generate the respective values of the ranking parameter, the server 202 can be configured to generate a third training set of data including a third plurality of training digital objects, a given one of which includes: (1) a training search query vector embedding 613 of a training search query 603 (such as that submitted by one of the users of the digital platform 210 in the past); (2) training document vector embeddings of a set of training digital documents 616, identified, in the search index database 206, as being responsive to the training search query 603, such as a training document embedding 617 of a given training digital document (not separately labelled); (3) a respective label 619 representative of how relevant the given training digital document represented by the training document vector embedding 617 is to the training search query 603; and (4) a training phrase vector embedding 615 of a plurality of training phrase candidates 605 that are lexically related to the training search query 603.

As mentioned hereinabove, the server 202 can be configured to generate the training search query vector embedding 613 and the training phrase vector embedding 615 using the first ML model 502 online, that is, in real time. By contrast, the server 202 can be configured to retrieve training document vector embeddings of the set of training digital documents 616 from the search index database 206, which training document vector embeddings the server 202 could be configured to generate using the second ML model 504 prior to generating the training search query and phrase vector embeddings 613, 615.

Further, according to certain non-limiting embodiments of the present technology, the respective label 619 can be provided by a given human assessor, who can, for example, be associated with a crowdsourcing platform (not depicted), such as an Amazon™ Mechanical Turk™ crowdsourcing platform or a Yandex™ Toloka™ crowdsourcing platform, with which the server 202 is communicatively coupled via the communication network 208. For example, the given human assessor can receive, via an interface of the crowdsourcing platform, a labelling instruction to assign the respective label 619 to the given training digital document represented by the training document vector embedding 617. According to certain non-limiting embodiments of the present technology, the respective label 619 comprises a respective value of the ranking parameter that can be selected, for example, from a range between “0” and “1”, where “0” indicates zero relevance of the given training digital document to the training search query 603, and “1” indicates that the given training digital document is relevant to the training search query 603. For example, the respective label 619 can take values 0.1, 0.25, 0.37, and the like.

In some non-limiting embodiments of the present technology, the respective label 619 for the given training digital document can be generated automatically by the server 202, for example, using an additional ML model that has been trained to determine how relevant the given training digital document is to the training search query 603 based on high-quality human assessor-generated labels. For example, the high-quality human assessor-generated labels can be provided by experts as opposed to human assessors of the crowdsourcing platform providing labels of lower quality than those of the experts.

Further, according to certain non-limiting embodiments of the present technology, the server 202 can be configured to identify the plurality of training phrase candidates 605 from the set of training digital documents 616 in a similar manner to that described above with reference to FIG. 4 with respect to identifying the plurality of phrase candidates 404 in the example digital document 402. Further, by feeding the plurality of training phrase candidates 605 to the first ML model 502, the server 202 can be configured to generate the training phrase vector embedding 615.

In some non-limiting embodiments of the present technology, to provide the information about the lexical relations between the training search query 603 and the set of training digital documents 616, instead of the training phrase vector embedding 615, the server 202 can be configured to use raw textual data of the training search query 603. More specifically, in some non-limiting embodiments of the present technology, the server 202 can be configured to include, in the third plurality of training digital objects, a number of times that a given search term of the training search query 603 is encountered in a respective one of the set of training digital documents 616. In other words, in these embodiments, the given one of the third plurality of training digital objects includes: (1) the training search query vector embedding 613 of the training search query 603; (2) the training document vector embeddings of the set of training digital documents 616, such as the training document embedding 617 of the given training digital document; (3) the respective label 619 representative of how relevant the given training digital document represented by the training document vector embedding 617 is to the training search query 603; and (4) integer values representative of how many times search terms of the training search query 603 are encountered in the given training digital document.

In some non-limiting embodiments of the present technology, the server 202 can be configured to use the raw textual data of the set of training digital documents 616 for generating the third training set of data differently. More specifically, instead of determining frequencies of occurrence of each entire search term of the training search query 603 in the given training digital document, in these alternative embodiments, the server 202 can be configured to: (i) divide the search terms of the training search query 603 into N-grams, such as bigrams or trigrams; (ii) determine a respective frequency of occurrence of each N-gram of the training search query in the given training digital document; and (iii) include, in the third plurality of training digital objects, respective integer values indicative of the respective frequencies of occurrence of each N-gram of the training search query 603 in the given training digital document of the set of training digital documents 616.

In other words, unlike in the embodiments directed to using the training phrase vector embedding 615 for injecting the information of the lexical relations between the training digital documents of the set of training digital documents 616 and the training search query 603, in some non-limiting embodiments of the present technology, the server 202 can be configured to use raw integer values representative of frequencies of occurrence of either entire search terms or N-grams of the training search query 603 in each training digital document in the set of training digital documents 616.

Further, to train the consolidated ML model 602 based on the third training set of data, the server 202 can be configured to: (i) at a given training iteration, feed the given training digital object of the third plurality of training digital objects to the consolidated ML model 602, thereby causing the consolidated ML model 602 to generate a respective current predicted value of the ranking parameter; and (ii) minimize a difference between the respective (actual) value of the ranking parameter indicated by the respective label 619 and the respective current predicted value generated by the consolidated ML model 602 at the given training iteration, thereby adjusting node weights of the consolidated ML model 602.

For example, in some non-limiting embodiments of the present technology, the server 202 can be configured to determine the difference between the respective actual and respective current predicted values of the ranking parameter by a loss function, such as a Cross-Entropy Loss function, as an example. It should be expressly understood that other implementations of the loss function are also envisioned by the non-limiting embodiments of the present technology and may include, by way of example, and not as a limitation, a Mean Squared Error Loss function, a Huber Loss function, a Hinge Loss function, and others. Also, it is not limited how the server 202 can be configured to minimize the loss function, and in some non-limiting embodiments of the present technology, depends generally on the differentiability of the loss function. For example, if the loss function is continuously differentiable, approaches to minimizing it can include, without limitation, a Gradient Descent algorithm, a Newton's optimization algorithm, and others. In those embodiments where the loss function is non-differentiable, to minimize it, the server 202 can be configured to apply at least one of a Direct algorithms, Stochastic algorithms, and Population algorithms, as an example.

Thus, feeding to the consolidated ML model 602 the training document vector embedding 617, as part of the given one of the third plurality of training digital objects, enables the consolidated ML model 602 to learn how the given digital document of the set of digital documents 214 is semantically (that is, by meaning) related to the search query 212. On the other hand, feeding to the consolidated ML model 602 the training phrase vector embedding 615 of the plurality of training phrase candidates 605 that are lexically related to the training search query 603 to the consolidated ML model 602 enables the consolidated ML model 602 to learn how the given digital document is lexically (that is, by linguistic forms) related to the search query 212.

As it can be appreciated, the third plurality of training digital object can include thousands, tens of thousands, or even hundreds of thousands training digital objects generated based on various training search queries, retrieved, for example, from historical data of interactions of the users with the digital platform 210. Thus, by feeding each and every training digital object to the consolidated ML model and minimizing the difference between the actual and predicted values of the ranking parameter, the server 202 can be configured to train the consolidated ML model 602 to generate the respective values of the ranking parameter for digital documents identified for in-use search queries, such as the set of digital documents 214 for the search query 212, considering both the semantic and lexical relations therebetween. How the server 202 can be configured to use the consolidated ML model 602 after the training process described above will now be described.

### In-Use Process

With reference to FIG. 8, there is depicted a schematic diagram of using the consolidated ML model 602 for ranking the digital documents, in accordance with certain non- limiting embodiments of the present technology.

More specifically, to use the consolidated ML model 602 for ranking the digital documents, according to certain non-limiting embodiments of the present technology, the server 202 can be configured to: (i) receive the search query 212 submitted by the user 216 to the digital platform 210; (ii) generate, using the first ML model 502, the search query vector embedding 512 as described above; (iii) identify, using, for example, the algebraic model, in the search index database 206, the set of digital documents 214 responsive to the search query 212 and respective document vector embeddings thereof, such as the document vector embedding 516 of the example digital document 402; (iv) identify, in the set of digital documents 214, the plurality of phrase candidates 404 that are lexically related to the search query 212; and (v) generate, using the first ML model 502, the phrase vector embedding 514 representative of the plurality of phrase candidates 404.

As mentioned hereinabove, in some non-limiting embodiments of the present technology, the server 202 can be configured to generate the document vector embeddings for each one of the plurality of digital documents of the digital platform 210, using the second ML model 504, prior to executing the in-use process of the consolidated ML model 602 and store the document vector embeddings in the search index database 206 for further use. Thus, once the server 202 has identified any set of digital documents for ranking, such as the set of digital documents 214, the server 202 can be configured to retrieve the respective documents vector embeddings, without the need to generate them in real time. This may help save computational resources of the server 202 on executing the in-use process of the consolidated ML model 602, thereby increasing the efficiency of generating the ranked set of digital documents 220.

Further, the server 202 can be configured to feed: (1) the search query vector embedding 512, (2) the phrase vector embedding 514, and (3) the document vector embeddings of the set of digital documents 214 to the consolidated ML model 602, thereby causing the consolidated ML model 602 to generate the respective values 702 of the ranking parameter for the set of digital documents 214. Further, the server 202 can be configured to rank the set of digital documents 214 in accordance with the respective values 702 of the ranking parameter, thereby generating the ranked set of digital documents 220. Finally, the server 202 can be configured to transmit the ranked set of digital documents 220 to the electronic device 204 for presentation of the ranked set of digital documents to the user 216.

As mentioned hereinabove in the description of the training process, in some non-limiting embodiments of the present technology, to provide the information of the lexical relations between the search query 212 and the set of digital documents 214, instead of the phrase vector embedding 514 of the plurality of the plurality of phrase candidates 404, the server 202 can be configured to generate and further feed to the consolidated ML model 602 in-use frequency vectors, a given one of which includes values that are indicative of how many time search terms of the search query 212 are encountered in the example digital document 402. For example, referring back to FIG. 4 where the search query 212 read “Macaron Recipe Pierre Herme”, the given in-use frequency vector for the example digital document 402 can include the following values [5, 0, 2] because (i) linguistic forms of the search term “Macaron” are encountered 5 times in the example digital document 402; (ii) there are no any forms of the search term “Recipe” in the document; and (iii) various forms of the search term “Pierre Herme” are encountered twice in the example digital document 402.

Thus, feeding the phrase vector embedding 514 or the in-use frequency vectors along

with the document vector embeddings of the set of digital documents 214 may allow the consolidated ML model 602 to generate the respective values 702 of the ranking parameter, considering not only the semantic relations between each one of the set of digital documents 214 and the search query 212, but also taking into account the lexical relations therebetween. In other words, providing the phrase vector embedding 514 to the consolidated ML model 602 may allow re-focusing the consolidated ML model 602 from determining how relevant each one of the set of digital documents 214 to the search query 212 only based on the semantic relations therebetween to determining relevance of each one of the set of digital documents 214 to the search query 212 based on both semantic and lexical relations therebetween.

This allows ranking the set of digital documents 214 such that the digital documents that are both semantically and lexically related to the search query 212 are assigned a relatively higher value of the ranking parameter than those that are related to the search query 212 either only semantically or only lexically. This may hence improve the user satisfaction of the user 216 with the ranked set of digital documents 220.

### Method

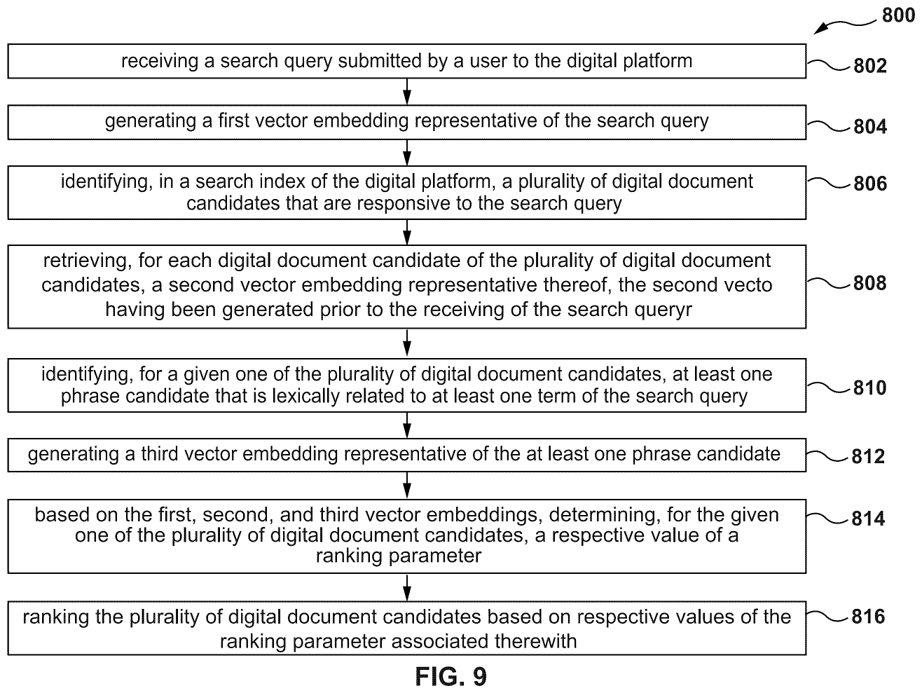

Given the architecture and the examples provided hereinabove, it is possible to execute a method for ranking digital documents, such as the set of digital documents 214. With reference now to FIG. 9, there is depicted a flowchart diagram of a method 900, according to certain non-limiting embodiments of the present technology. The method 900 may be executed by the server 202.

### Step 902: Receiving a Search Query Submitted By a User to the Digital Platform

The method 900 commences at step 902 with the server 202 being configured to receive the search query 212, which the user 216 of the electronic device 204 has submitted to the digital platform 210.

The method 900 hence advances to step 904.

### Step 904: Generating a First Vector Embedding Representative of the Search Query

At step 904, according to certain non-limiting embodiments of the present technology, the server 202 can be configured to generate the search query vector embedding 512 of the search query 212 received at step 902. To do so, according to certain non-limiting embodiments of the present technology, the server 202 can be configured to use the first ML model 502 that was trained to generate vector embeddings of input phrases as described above with reference to FIG. 5.

The method 900 hence advances to step 906

Step 906: Identifying, in a Search Index Of the Digital Platform, a Plurality of Digital Document Candidates that are Responsive to the Search Query

At step 906, according to certain non-limiting embodiments of the present technology, the server 202 can be configured to identify, in the search index database 206 of the digital platform 210, the set of digital documents 214 that are responsive to the search query 212. In this regard, as described above, the server 202 can be configured to apply the algebraic model, which can comprise, for example, the Okapi BM25 ranking function.

The method 900 hence advances to step 908.

### Step 908: Retrieving, for Each Digital Document Candidate of the Plurality of Digital Document Candidates, a Second Vector Embedding Representative Thereof, the Second Vector Having Been Generated Prior to the Receiving of the Search Query

At step 908, according to certain non-limiting embodiments of the present technology,

the server 202 can be configured to obtain, for each digital document of the set of digital documents 214, the respective document vector embedding, such as the document vector embedding 516 of the example digital document 402 of the set of digital documents 214.

As mentioned hereinabove, prior to the receiving the search query 212 at step 902, according to certain non-limiting embodiments of the present technology, the server 202 could be configured to generate the document vector embedding 516 using the second ML model 502 that has been trained to generate vector embeddings of input digital documents as described above with reference to FIG. 6. Further, the server 202 can be configured to store the document vector embedding 516 in the search index database 206 in association with the example digital document 402 for further use thereof for ranking the digital documents.

The method 900 hence advances to step 910.

Step 910: Identifying, for a Given One of the Plurality of Digital Document Candidates. at Least One Phrase Candidate that is Lexically Related to at Least One Term of the Search Query

At step 910, according to certain non-limiting embodiments of the present technology, the server 202 can be configured to identify, in the given digital document of the set of digital documents 214, at least one phrase candidate that is lexically related to the search query 212—such as the plurality of phrase candidates 404 identified in the example digital document 402 as described above with reference to FIG. 4.

More specifically, in some non-limiting embodiments of the present technology, the server 202 can be configured to: (i) generate, for each phrase of the example digital document 402, a respective vector including a numerical representation of the given phrase in the given embedding space; (ii) determine, using the respective vectors, for each phrase of the example digital document 402, the respective value of the similarity metric to the search query 212; (iii) rank the phrases of the example digital document 402 according to the respective values of the similarity metric thereof; and (iv) select a top-N number of phrases for inclusion in the plurality of phrase candidates that are lexically related to the search query 212. As mentioned hereinabove, in some non-limiting embodiments of the present technology, the similarity metric can be indicative of a distance between a respective vector representative of a given phrase of the example digital document 402 and the vector representative of the search query 212 in the given embedding space. In some non-limiting embodiments of the present technology, the similarity metric can comprise a cosine similarity metric.

The method 900 hence advances to step 912.

### Step 912: Generating a Third Vector Embedding Representative of the at Least One Phrase Candidate

At step 912, according to certain non-limiting embodiments of the present technology, the server 202 can be configured to generate the phrase vector embedding 514 of the plurality of phrase candidates 404 that are lexically related to the search query 212. To do so, the server 202 can be configured to use the first ML model 502 that was trained to generate vector embeddings of input phrases as described above with reference to FIG. 5.

In other non-limiting embodiments, instead of the phrase vector embedding 514, the server 202 can be configured to generate the in-use frequency vectors, the given one of which includes values that are indicative of how many time search terms of the search query 212 are encountered in the example digital document 402, as described above with reference to FIGS. 4 and 8.

The method 900 hence advances to step 914.

### Step 914: Based on the First, Second, and Third Vector Embeddings, Determining, for the Given One of the Plurality of Digital Document Candidates, a Representative Value of a Ranking Parameter

At step 914, based on the search vector embedding 512, the document vector embeddings of each one of the set of digital documents 214, and the phrase vector embedding 514 (or the in-use frequency vectors of the search terms of the search query 212) of the plurality of phrase candidates 404 that are lexically related to the search query 202, the server 202 can be configured to rank the set of digital documents 214 considering their lexical and semantic relations with the search query 212.

To that end, according to certain non-limiting embodiments of the present technology, the server 202 can be configured to use the consolidated ML model 602 that has been trained as described above with reference to FIG. 7. More specifically, as described further above with reference to FIG. 8, the server 202 can be configured to feed: (1) the search query vector embedding 512, (2) the phrase vector embedding 514, and (3) the document vector embeddings of the set of digital documents 214 to the consolidated ML model 602, thereby causing the consolidated ML model 602 to generate the respective values 702 of the ranking parameter for the set of digital documents 214. As mentioned above, a given value of the ranking parameter is indicative of how the respective digital document is relevant to the search query 212.

### Step 916: Ranking the Plurality of Digital Document Candidates Based on Respective Values of the Ranking Parameter Associated Therewith

Finally, at step 916, according to certain non-limiting embodiments of the present technology, the server 202 can be configured to rank the set of digital documents 214 in accordance with the respective values 702 of the ranking parameter thereof determined at step 914, thereby generating the ranked set of digital documents 220. Further, the server 202 can be configured to transmit the ranked set of digital documents 220 to the electronic device 204 for presentation thereof to the user 216.

The method 900 hence terminates.

Thus, certain embodiments of the method 900 may allow “injecting”, to the consolidated ML model 602, the information indicative of lexical relations between the digital documents and the search query 212, which may further allow ranking the set of digital documents 214 such that the digital documents that are both semantically and lexically related to the search query 212 are assigned a relatively higher value of the ranking parameter than those that are related to the search query 212 either only semantically or only lexically. This may hence improve the user satisfaction of the user 216 with the ranked set of digital documents 220.

It will also be understood that, although the embodiments presented herein have been described with reference to specific features and structures, various modifications and combinations may be made without departing from such disclosures. For example, various optimizations that have been applied to neural networks, including transformers and/or BERT may be similarly applied with the disclosed technology. Additionally, optimizations that speed up in-use relevance determinations may also be used. For example, in some implementations, the transformer model may be split, so that some of the transformer blocks are split between handling a query and handling a document, so the document representations may be pre-computed offline and stored in a document retrieval index. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

What is claimed is:

1. A computer-implemented method for ranking digital documents at a digital platform, the method comprising:
receiving a search query submitted by a user to the digital platform;
generating a first vector embedding representative of the search query;
identifying, in a search index of the digital platform, a plurality of digital document candidates that are responsive to the search query;
retrieving, for each digital document candidate of the plurality of digital document candidates, a second vector embedding representative thereof, the second vector having been generated prior to the receiving of the search query;
identifying, for a given one of the plurality of digital document candidates, at least one phrase candidate that is lexically related to at least one term of the search query;
generating a third vector embedding representative of the at least one phrase candidate;
based on the first, second, and third vector embeddings, determining, for the given one of the plurality of digital document candidates, a respective value of a ranking parameter,
the ranking parameter being indicative of relevancy of the given of the plurality of digital document candidates to the search query; and
ranking the plurality of digital document candidates based on respective values of the ranking parameter associated therewith.

2. The method of claim 1, wherein the identifying the plurality of digital document candidates comprises applying a ranking function.

3. The method of claim 2, wherein the ranking function is an Okapi BM25 ranking function.

4. The method of claim 1, wherein the identifying the at least one phrase candidate comprises:
generating, for each phrase of a given one the plurality of digital document candidates, a respective phrase vector embedding;
determining, in an embedding space, a distance value between the first vector embedding, representative of the search query, and the respective phrase vector embedding;
ranking phrases of the plurality of digital document candidates in accordance with respective distance values associated with respective phrase embeddings, thereby generating a ranked list of phrases for the search query; and
selecting, from the ranked list of phrases, a top predetermined number of phrases.

5. The method of claim 4, wherein the generating the respective phrase vector embedding comprises determining, for each term of the search query, a term frequency-inverse document frequency (TF-IDF) value, within a given one of the plurality of digital document candidates.

6. The method of claim 4, wherein the generating the respective phrase vector embedding comprises applying thereto a text embedding algorithm.

7. The method of claim 6, wherein the text embedding algorithm is a FastText word embedding algorithm.

8. The method of claim 1, wherein the determining comprises feeding the first, second, and third vector embeddings to a consolidated ML model,
the consolidated ML model having been trained to determine the respective values of the ranking parameter for each one of a given plurality of digital documents based on vector embeddings of (i) a respective search query used for identifying the given plurality of digital documents; (ii) each one of the given plurality of digital documents responsive to the respective search query; and (iii) at least one phrase candidate identified in the given plurality of digital documents as being lexically related to at least one term of the respective search query.

9. The method of claim 8, further comprising training the consolidated ML model by:
generating a training set of data comprising a plurality of training digital objects, a given one of which comprises: (i) a training vector embedding of a training search query; (ii) training vector embeddings of a plurality of training digital documents candidates responsive to the training search query; and (ii) training phrase vector embedding of at least one training phrase candidate, identified in the plurality of training digital documents, that is lexically related to at least one term of the training search query; and (iv) a respective label for a given one of the plurality of training digital documents, the respective label being indicative of how relevant the given one of the plurality of training digital documents is to the training search query;
feeding the plurality of training digital objects to the consolidated ML model; and
minimizing, at each training iteration, a difference between a current training prediction of the consolidated ML model and the respective label.

10. The method of claim 9, wherein the respective label is generated by an ML model that has been pre-trained, based on human assessor-generated labels, to determine a degree of relevancy of the given digital document to the respective search query.

11. The method of claim 8, wherein the consolidated ML model comprises a Deep Semantic Similarity ML model.

12. The method of claim 1, wherein the retrieving the second vector embedding comprises receiving the second vector embedding from a second ML model that has been trained to generate vector embeddings of input digital documents.

13. The method of claim 12, further comprising training the second ML model by feeding thereto the plurality of digital documents of the search index of the digital platform.

14. The method of claim 1, wherein, prior to the determining, the method further comprises reducing a number of embeddings of each one of the first, second, and third vector embeddings.

15. The method of claim 14, wherein:
the generating the first, second, and third vector embeddings comprises applying a Transformer-based machine-learning (ML) model; and
the reducing the number of embeddings comprises progressively truncating outputs of each intermediate layer of the Transformer-based ML model to a respective predetermined length of a given one of the first, second, and third vector embeddings.

16. The method of claim 1, wherein the generating the first and third vector embeddings is conducted independently of generating the second vector embedding.

17. The method of claim 1, wherein the generating the first vector embedding representative of the search query and the generating the third vector embedding representative of the at least one phrase candidate comprises applying an ML model that has been trained to generate vector embeddings of input phrases.

18. The method of claim 17, further comprising training the ML model by:
generating a training set of data comprising a plurality of training digital objects, a given one of which comprises: (i) a training search query; and (ii) a plurality of training phrase candidates, identified in a respective plurality of training digital documents responsive to the training search query, that are lexically related to at least one term of the training search query; and
feeding the plurality of training digital objects to the ML model.

19. The method of claim 1, wherein, during the identifying the at least one phrase candidate that is lexically related to at least one term of the search query for the given one of the plurality of digital document candidates, the method further comprises using an unprocessed version of the given one of the plurality of digital document candidates.

20. A server for ranking digital documents at a digital platform, the server comprising at least processor and at least one non-transitory computer-readable memory comprising executable instructions, which, when executed by the at least one processor, cause the server to:
receive a search query submitted by a user to the digital platform;
generate a first vector embedding representative of the search query;
identify, in a search index of the digital platform, a plurality of digital document candidates that are responsive to the search query;
retrieve, for each digital document candidate of the plurality of digital document candidates, a second vector embedding representative thereof, the second vector having been generated prior to the receiving of the search query;
identify, for a given one of the plurality of digital document candidates, at least one phrase candidate that is lexically related to at least one term of the search query;
generate a third vector embedding representative of the at least one phrase candidate;
based on the first, second, and third vector embeddings, determine, for the given one of the plurality of digital document candidates, a respective value of a ranking parameter,
the ranking parameter being indicative of relevancy of the given of the plurality of digital document candidates to the search query; and
rank the plurality of digital document candidates based on respective values of the ranking parameter associated therewith.
